(19) United States
(12) Patent Application Publication
(10) Pub. No.: US 2026/0302423 A1
(43) Pub. Date: Oct. 1, 2026

(54) BATTERY CONTAINER

(71) Applicant: LG ENERGY SOLUTION, LTD., Seoul (KR)

(72) Inventors: In-Ho JUNG, Daejeon (KR); Jin-Hong AN, Daejeon (KR); Yong-Tae LEE, Daejeon (KR)

(73) Assignee: LG ENERGY SOLUTION, LTD., Seoul (KR)

(21) Appl. No.: 19/576,919

(22) Filed: Mar. 24, 2026

(30) Foreign Application Priority Data
Mar. 25, 2025 (KR) 10-2025-0038077
Mar. 4, 2026 (KR) 10-2026-0039183

(51) Int. Cl. H01M 10/6568; H01M 10/613; H01M 10/627; H01M 50/204; H01M 50/251

(52) U.S. Cl. CPC H01M 10/6568; H01M 10/613; H01M 10/627; H01M 50/204; H01M 50/251; H01M 2220/10

(57) ABSTRACT

A battery container includes: a battery pack; a chiller that supplies a cooling liquid to the battery pack; a first pipe that communicates with the battery pack; a second pipe that communicates with the chiller; and an expansion section that provides communication between the first pipe and the second pipe, and a cross-sectional area of the expansion section is larger than each of cross-sectional areas of the first pipe and the second pipe.

### CROSS REFERENCES TO RELATED APPLICATIONS

This application is based on and claims priority from Korean Patent Application No. 10-2025-0038077, filed on Mar. 25, 2025, with the Korean Intellectual Property Office, and Korean Patent Application No. 10-2026-0039183, filed on Mar. 4, 2026, with the Korean Intellectual Property Office, the disclosures of which are incorporated herein in their entirety by reference.

### TECHNICAL FIELD

The present disclosure relates to a battery container.

### BACKGROUND

Currently, commercially available secondary batteries include, for example, nickel-cadmium batteries, nickel-hydrogen batteries, nickel-zinc batteries, and lithium secondary batteries. Among these batteries, lithium secondary batteries are gaining considerable attention due to their advantages including a substantially low memory effect to allow a high degree of freedom in charging and discharging, a very low self-discharging rate, and high energy density, as compared to nickel-based secondary batteries.

Recently, as the issues of power shortages and environment-friendly energy have risen in significance, energy storage systems (ESS) for storing generated power are drawing greater attention. For example, a smart grid system has been proposed as an approach to adjust power supply and demand. The amount of power consumed by consumers is not always constant and may fluctuate frequently. Typically, for example, power consumption increases sharply during summer afternoons due to the use of air-conditioning systems, but decreases rapidly at night. On the power consumption side, the amount of power consumed is not constant and may fluctuate over time, whereas on the power supply side, it is practically difficult to match the fluctuation in power consumption even though the amount of power generated is adjusted to some extent. The imbalance between the power supply and the power consumption may cause an oversupply or a shortage of power. As a measure to resolve the problems, the smart grid system may flexibly store and regulate power. The smart grid system may refer to a concept in which power is stored at times when or in regions where surplus power is generated, and the stored power is supplied at times when or in regions where power shortages occur. A key component for implementing the smart grid system may be an energy storage system for storing power. In recent years, as electric vehicles have been commercialized in earnest, the energy storage system may also be applied to facilities for charging electric vehicles such as charging stations.

The energy storage system may include a plurality of battery containers. Each battery container may include a plurality of battery packs. Further, the battery container may include a cooling system for cooling the plurality of battery packs.

The pH of a cooling liquid may decrease over time. The cooling liquid with the decreased pH may damage pipes or other components. Accordingly, it is necessary to maintain the pH of the cooling liquid in an appropriate range. To this end, a structure capable of extracting a small amount of cooling liquid to monitor the pH is required.

### SUMMARY

The present disclosure provides a structure capable of extracting a cooling liquid flowing in a battery container.

The present disclosure provides a structure capable of partially decreasing the flow velocity or pressure of the cooling liquid to extract the cooling liquid in a small amount.

Further, the present disclosure provides a structure capable of extracting the cooling liquid even during the operation of a cooling system.

The objects sought to be achieved by the present disclosure are not limited to those described above, and other objects that are not described herein may clearly be understood by those skilled in the art from the descriptions of the invention herein below.

According to an embodiment of the present disclosure, a battery container includes: a battery pack; a chiller that supplies a cooling liquid to the battery pack; a first pipe that communicates with the battery pack; a second pipe that communicates with the chiller; and an expansion section that provides communication between the first pipe and the second pipe, and a cross-sectional area of the expansion section is larger than each of cross-sectional areas of the first pipe and the second pipe.

The battery container may further include a third pipe communicating with the expansion section.

The battery container may further include a valve to open and close the third pipe.

The third pipe may communicate with a portion of the expansion section, and a cross-sectional area of the portion is larger than the each of cross-sectional areas of the first pipe and the second pipe.

The expansion section may include a first part having a cross-sectional area that increases along a direction from the first pipe toward the second pipe.

The expansion section may include a second part having a cross-sectional area that decreases along the direction from the first pipe toward the second pipe.

The third pipe may communicate with a portion of the expansion section between the first part and the second part.

The third pipe may communicate with a portion of the expansion section having the largest cross-sectional area.

One end of the third pipe may be opened.

According to another embodiment of the present disclosure, an energy storage system includes the battery container of the present disclosure.

The battery container above may further include: a fourth pipe that allows the cooling liquid flowing out from the battery pack to flow therethrough, and causes the battery pack and the chiller to communicate with each other.

The first pipe may supply the cooling liquid to a plurality of battery packs through a plurality of first branch pipes, and the fourth pipe may collect the cooling liquid from the plurality of battery packs through a plurality of second branch pipes.

The expansion section may have a spherical or ellipsoidal shape, which is symmetrical relative to a central axis at which the third pipe communicates with the expansion section.

The valve may be any one of a roller clamp, a flow regulator, or an infusion pump.

The expansion section may further include a third part formed between the first part and the second part, extending from the first part, and having a cross-sectional area that is constant along a flow direction of the cooling liquid, and the third pipe may communicate with the third part.

According to an embodiment of the present disclosure, a cooling liquid flowing in a battery container may be extracted in a small amount.

According to an embodiment of the present disclosure, the cooling liquid may be extracted even during the operation of a cooling system of the battery container.

According to an embodiment of the present disclosure, the durability of the battery container may be improved.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a view illustrating a battery container according to an embodiment of the present disclosure.

FIG. 2 is an exploded view illustrating a portion of the configuration of the battery container of FIG. 1.

FIG. 3 is a view illustrating a container module of FIG. 2.

FIG. 4 is a view illustrating a state where a door panel of the container module of FIG. 3 is opened.

FIG. 5 is an enlarged view of region A in FIG. 4.

FIG. 6 is a view illustrating a cooling system of the container module of FIG. 3.

FIG. 7 is a view illustrating a portion of the configuration of FIG. 5.

FIG. 8 is a view illustrating a configuration of a cross section taken along line B-B′ of FIG. 7.

FIG. 9 is a view illustrating a state where a valve in FIG. 8 is opened.

FIG. 10 is a view illustrating a modification of FIG. 8.

In some of the accompanying drawings, corresponding components will be denoted with the same reference numerals. The drawing figures presented are illustrated for simplicity and clarity and have not necessarily been drawn to scale. For example, the dimensions of some elements in the figures may be exaggerated relative to other elements to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described with reference to the accompanying drawings. Words and terms used in the detailed description and the claims herein should not be interpreted to be limited to their usual or dictionary meanings, but should be interpreted to have meanings and concepts that correspond to the technical idea of the present disclosure in compliance with the principle that inventors may appropriately define terms and concepts for the purpose of best describing the present disclosure.

Accordingly, it can be appreciated that the embodiments described herein and the configurations illustrated in the drawings are merely examples of the present disclosure, which do not exhaustively represent the technical idea of the present disclosure, and various equivalents and modifications may be made to substitute the present disclosure at the time of filing the present disclosure.

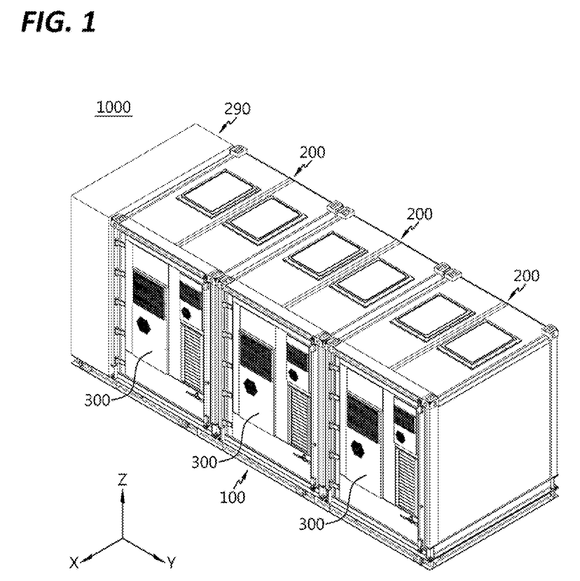

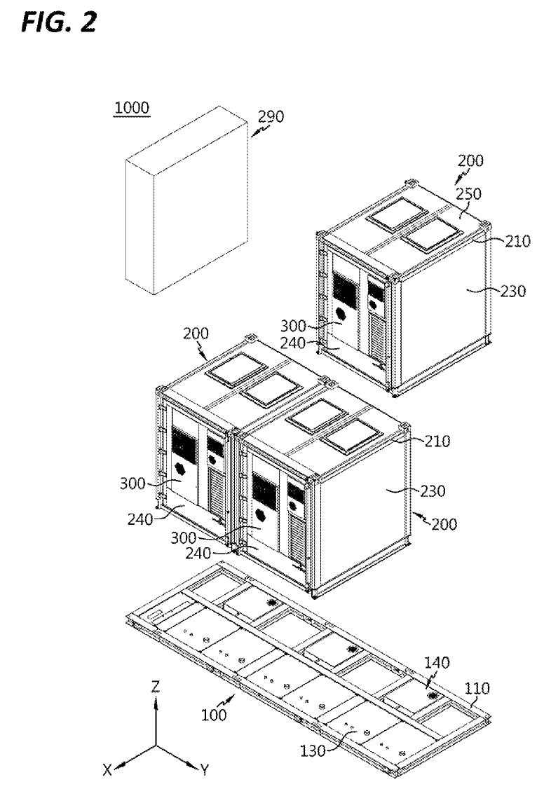

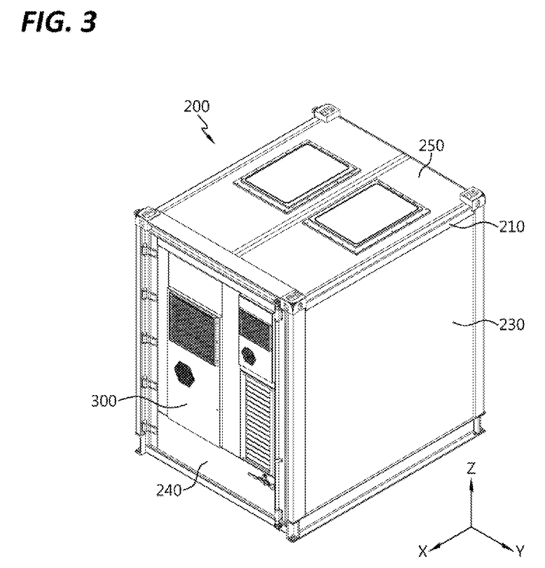

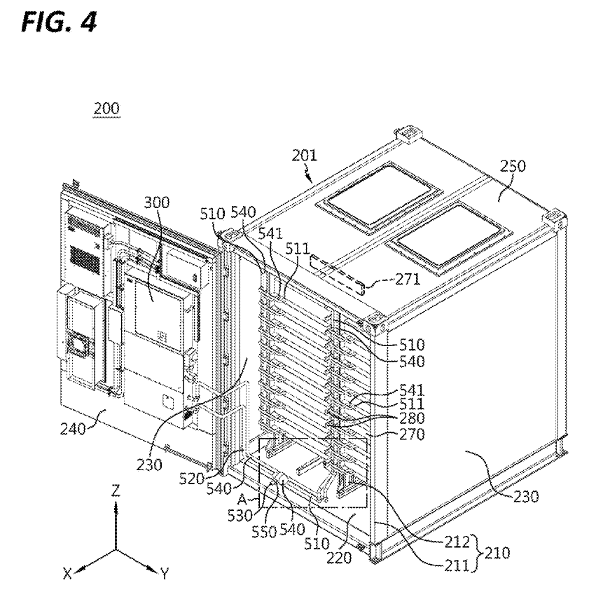

FIG. 1 is a view illustrating a battery container 1000 according to an embodiment of the present disclosure. FIG. 2 is an exploded view illustrating a portion of the configuration of the battery container 1000 of FIG. 1. FIG. 3 is a view illustrating a container module 200 of FIG. 2. FIG. 4 is a view illustrating a state where a door panel 240 of the container module 200 of FIG. 3 is opened.

Referring to FIGS. 1 to 4, the battery container 1000 may include the container module 200. A plurality of container modules 200 may be provided. Each container module 200 may have a rectangular prism shape. The container modules 200 may form the exterior of the battery container 1000. The plurality of container modules 200 may be arranged along the left-right direction or the Y-axis direction.

The container module 200 may include a case 201 that provides space therein. The case 201 may have a rectangular prism shape. The case 201 may form the exterior of the container module 200.

The case 201 may include a frame 210. The frame 210 may include an outer frame 211. The outer frame 211 may form the exterior of the case 201. A bottom panel 220 may be fastened, coupled, installed, fixed, or attached in/to the lower surface of the outer frame 211. The bottom panel 220 may form the exterior of the case 201. A side panel 230 may be fastened, coupled, installed, fixed, or attached in/to the side surface of the outer frame 211. The side panel 230 may form the exterior of the case 201. A pair of side panels 230 may be provided. The pair of side panels 230 may face each other. A rear panel 260 may be fastened, coupled, installed, fixed, or attached in/to the rear surface of the outer frame 211. The rear panel 260 may form the exterior of the case 201. A top panel 250 may be fastened, coupled, installed, fixed, or attached in/to the upper surface of the outer frame 211. The top panel 250 may form the exterior of the case 201. The top panel 250 and the bottom panel 220 may face each other. A door panel 240 may be fastened, coupled, installed, fixed, or attached in/to the front surface of the outer frame 211. The door panel 240 may form the exterior of the case 201. The door panel 240 and the rear panel 260 may face each other. The door panel 240 may open/close the interior of the case 201. The door panel 240 may be hinge-coupled to the frame 210.

A battery pack 270 may be accommodated in the case 201. The battery pack 270 may include a plurality of battery cells 271. Here, the battery cells 271 may refer to secondary batteries. A plurality of battery packs 270 may be provided. Each battery cell 271 may be a pouch-type secondary battery. However, the shape of the battery cell 271 is not limited to the pouch shape, and may include various shapes such as, for example, a cylindrical shape and a rectangular prism shape.

The frame 210 may include an inner frame 212. The inner frame 212 may be provided in the case 201. The inner frame 212 may extend along the up-down direction or the Z-axis direction. A bracket 280 may be provided in the case 201. The bracket 280 may be fastened, coupled, installed, fixed, or attached in/to the inner frame 212. The battery pack 270 may be fastened, coupled, installed, fixed, or attached in/to the bracket 280. The plurality of battery packs 270 may be arranged along the up-down direction or the Z-axis direction. The plurality of battery packs 270 may be arranged along the left-right direction or the Y-axis direction. The plurality of battery packs 270 may be arranged along the front-rear direction or the X-axis direction. Each battery pack 270 may also be referred to as a battery module 270, a battery assembly 270, or a battery stack 270.

A base panel assembly 100 may have a rectangular prism shape. The base panel assembly 100 may provide a space therein. The container module 200 may be installed, fastened, coupled, or fixed on the base panel assembly 100. The plurality of container modules 200 may be installed, fastened, coupled, or fixed on the base panel assembly 100.

The base panel assembly 100 may include a base frame 110. The base frame 110 may form the exterior of the base panel assembly 100.

The base panel assembly 100 may include a base panel 130. The base panel 130 may be installed, fastened, coupled, or fixed in/to the base frame 110.

The base panel assembly 100 may include a tank 140. The tank 140 may communicate with the container module 200. The tank 140 may store a liquid flowing out from the container module 200. The tank 140 may be accommodated, installed, coupled, fastened, or fixed in/to the base panel assembly 100.

A control module 290 may be installed, fastened, coupled, or fixed on the base panel assembly 100. The control module 290 may be electrically connected to the container module 200. The control module 290 may be electrically connected to each of the plurality of container modules 200. The control module 290 may control, for example, the charging/discharging or the temperature of the container module 200.

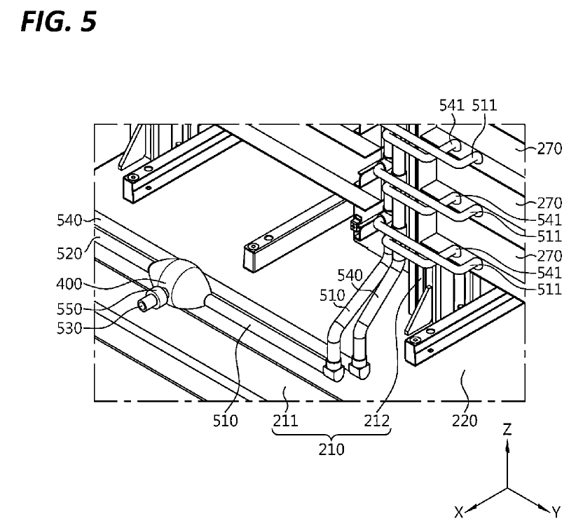

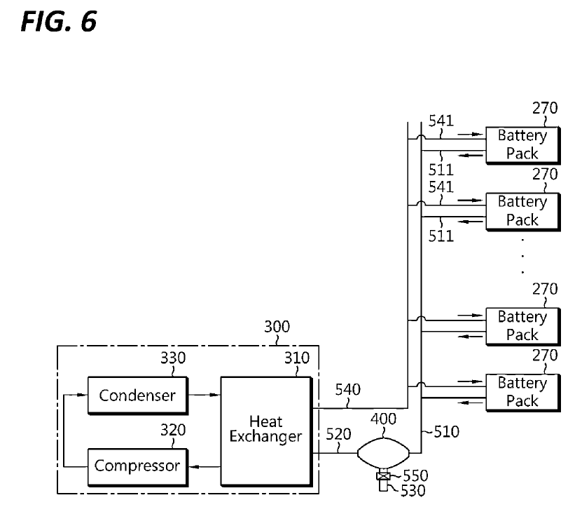

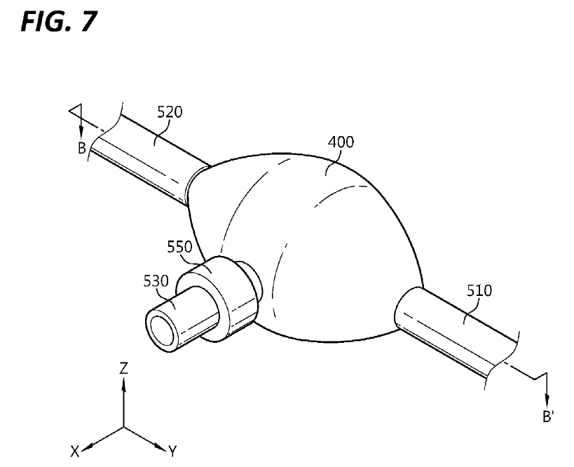

FIG. 5 is an enlarged view of the region A in FIG. 4. FIG. 6 is a view illustrating a cooling system of the container module 200 of FIG. 3. FIG. 7 is a view illustrating a portion of the configuration of FIG. 5.

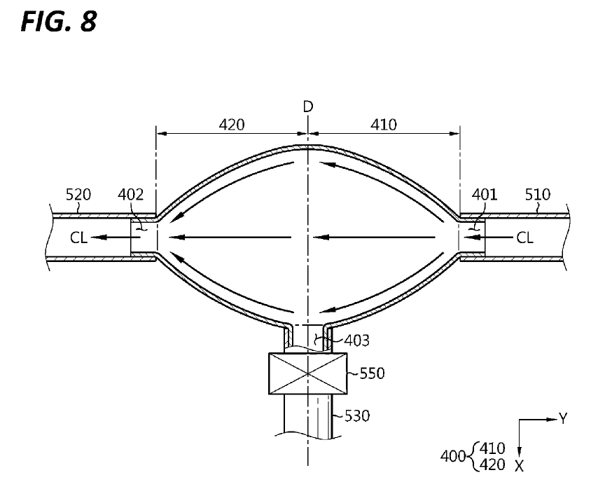

Referring to FIGS. 5 to 7, the container module 200 may include a first pipe 510. The first pipe 510 may be disposed, installed, or fixed inside the case 201. The first pipe 510 may communicate with the battery pack 270. The first pipe 510 may communicate with the plurality of battery packs 270. The first pipe 510 may communicate with a plurality of first branch pipes 511. Each of the plurality of first branch pipes 511 may communicate with the battery pack 270. A cooling liquid CL (see, e.g., FIG. 8) may flow along the first pipe 510. The cooling liquid CL may be, for example, water. The cooling liquid CL may flow along the first branch pipe 511. The cooling liquid CL may flow into or out from the battery pack 270 through the first branch pipe 511. The cooling liquid CL may flow into the battery pack 270 for heat exchange. The cooling liquid CL may be supplied into the battery pack 270 through the first branch pipe 511. The cooling liquid CL may flow out from the battery pack 270 through the first branch pipe 511. The first pipe 510 may communicate with an expansion section 400. The cooling liquid CL may flow into the expansion section 400 through the first pipe 510. The cooling liquid CL may flow out from the expansion section 400 through the first pipe 510.

The expansion section 400 may be disposed on the bottom panel 220. The expansion section 400 may be disposed in front of the plurality of battery packs 270. The expansion section 400 may be disposed between the plurality of battery packs 270 and the door panel 240.

The container module 200 may include a second pipe 520. The second pipe 520 may be disposed, installed, or fixed inside the case 201. The second pipe 520 may communicate with the expansion section 400. The cooling liquid CL may flow out from the expansion section 400 through the second pipe 520. The cooling liquid CL may flow into the expansion section 400 through the second pipe 520.

The container module 200 may include a third pipe 530. The third pipe 530 may be disposed, installed, or fixed inside the case 201. One end of the third pipe 530 may communicate with the expansion section 400. The other end of the third pipe 530 may be opened. The third pipe 530 may be disposed between the first pipe 510 and the second pipe 520.

A valve 550 may be installed, coupled, fastened, or provided on the third pipe 530. The valve 550 may open or close the third pipe 530. When the valve 550 opens the third pipe 530, the cooling liquid CL may flow out.

The valve 550 may be, for example, a roller clamp. The valve 550 may be, for example, a flow regulator. The valve 550 may be, for example, an electronic flow controller (e.g., an infusion pump).

The second pipe 520 may communicate with a chiller 300. The chiller 300 may be installed, coupled, fastened, or provided on the door panel 240. The chiller 300 may supply the cooling liquid CL to the battery pack 270. The cooling liquid CL may flow into or out from the chiller 300 through the second pipe 520. The chiller 300 may include a heat exchanger 310, a compressor 320, or a condenser 330. The chiller 300 may include a refrigerant. The refrigerant may circulate through the heat exchanger 310, the compressor 320, or the condenser 330. The cooling liquid CL may exchange heat with the refrigerant through the heat exchanger 310. When the cooling liquid CL is at a high temperature, the temperature of the cooling liquid CL may be lowered through the heat exchanger 310. The cooling liquid CL flowing into the chiller 300 may be at a high temperature. The cooling liquid CL flowing out from the chiller 300 may be at a low temperature.

The container module 200 may include a fourth pipe 540. The fourth pipe 540 may be disposed, installed, or fixed inside the case 201. The fourth pipe 540 may communicate with the battery pack 270. The fourth pipe 540 may communicate with the plurality of battery packs 270. The fourth pipe 540 may communicate with a plurality of second branch pipes 541. Each of the plurality of second branch pipes 541 may communicate with the battery pack 270. The cooling liquid CL may flow along the fourth branch pipe 540. The cooling liquid CL may flow along the second branch pipe 541. The cooling liquid CL may flow into or out from the battery pack 270 through the second branch pipe 541. The cooling liquid CL may flow into the battery pack 270 for heat exchange. The cooling liquid CL may be supplied into the battery pack 270 through the second branch pipe 541. The cooling liquid CL may flow out from the battery pack 270 through the second branch pipe 541. Each battery pack 270 may communicate with the first branch pipe 511 and the second branch pipe 541.

The cooling liquid CL supplied from the chiller 300 may flow through the fourth pipe 540. The cooling liquid CL may flow into the battery pack 270 through the second branch pipe 541. The cooling liquid CL may flow out from the battery pack 270 through the first branch pipe 511 after the heat exchange with the battery pack 270. The cooling liquid CL may flow into the first pipe 510. The cooling liquid CL may flow into the expansion section 400. The cooling liquid CL may flow into the chiller 300 through the second pipe 520.

Alternatively, the cooling liquid CL supplied from the chiller 300 may flow through the second pipe 520. The cooling liquid CL may flow into the expansion section 400. The cooling liquid CL may flow out from the expansion section 400 through the first pipe 510. The cooling liquid CL may flow into the battery pack 270 through the first branch pipe 511. The cooling liquid CL may flow out from the battery pack 270 through the second branch pipe 541 after the heat exchange with the battery pack 270. The cooling liquid CL may flow into the fourth branch pipe 540. The cooling liquid CL may flow into the chiller 300 through the fourth pipe 540.

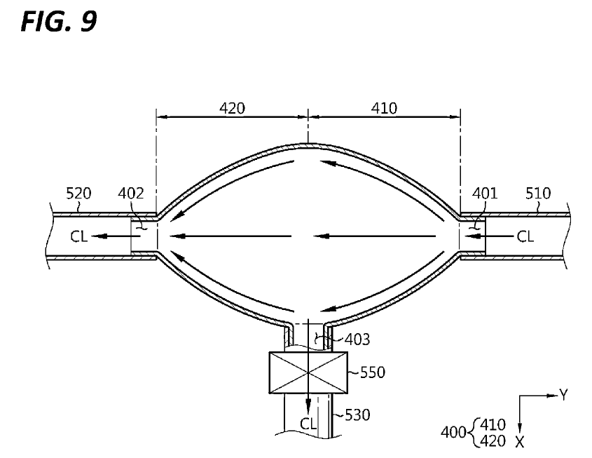

FIG. 8 is a view illustrating the configuration of the cross-section taken along the line B-B′ of FIG. 7. FIG. 9 is a view illustrating the state where the valve 550 in FIG. 8 is opened.

Referring to FIGS. 7 to 9, the expansion section 400 may have a spherical shape. Alternatively, the expansion section 400 may have an ellipsoidal shape. The expansion section 400 may include an inlet 401. The inlet 401 may communicate with the first pipe 510. The expansion section 400 may include an outlet 402. The outlet 402 may communicate with the second pipe 520.

The expansion section 400 may include a first part 410. The first part 410 may have the cross-sectional area that increases along the direction from the first pipe 510 toward the second pipe 520. The first part 410 may have the cross-sectional area that increases along the -Y-axis direction. The first part 410 may have the cross-sectional area that increases along the flow direction of the cooling liquid CL. The first part 410 may have the cross-sectional area that increases along the direction from the inlet 401 toward the outlet 402. The cross-sectional area of the first part 410 may be larger than that of the first pipe 510. The cross-sectional area of the first part 410 may be larger than that of the second pipe 520. Here, the cross-sectional area may refer to the cross section in the direction perpendicular to the Y axis. When the cooling liquid CL flows through the first part 410, the flow velocity thereof may decrease. The flow velocity of the cooling liquid CL flowing through the first part 410 may be lower than the flow velocity of the cooling liquid CL flowing through the first pipe 510. The flow velocity of the cooling liquid CL flowing through the first part 410 may be lower than the flow velocity of the cooling liquid CL flowing through the second pipe 520.

The expansion section 400 may include a second part 420. The second part 420 may extend from the first part 410. The first part 410 and the second part 420 may be configured to be symmetrical with each other about a symmetry axis D. The second part 420 may have the cross-sectional area that decreases along the direction from the first pipe 510 toward the second pipe 520. The second part 420 may have the cross-sectional area that decreases along the -Y-axis direction. The second part 420 may have the cross-sectional area that decreases along the flow direction of the cooling liquid CL. The second part 420 may have the cross-sectional area that decreases along the direction from the inlet 401 toward the outlet 402. The cross-sectional area of the second part 420 may be larger than that of the first pipe 510. The cross-sectional area of the second part 420 may be larger than that of the second pipe 520. When the cooling liquid CL flows through the second part 420, the flow velocity thereof may increase. The flow velocity of the cooling liquid CL flowing through the second part 420 may be lower than the flow velocity of the cooling liquid CL flowing through the first pipe 510. The flow velocity of the cooling liquid CL flowing through the second part 420 may be lower than the flow velocity of the cooling liquid CL flowing through the second pipe 520.

The expansion section 400 may include an outlet 403. The outlet 403 may communicate with the third pipe 530. The third pipe 530 may communicate with the expansion section 400 having the larger cross-sectional area than that of the first pipe 510. The third pipe 530 may communicate with the expansion section 400 having the larger cross-sectional area than that of the second pipe 520.

The flow velocity of the cooling liquid CL flowing through the outlet 403 may be lower than the flow velocity of the cooling liquid CL flowing through the first pipe 510. The flow velocity of the cooling liquid CL flowing through the outlet 403 may be lower than the flow velocity of the cooling liquid CL flowing through the second pipe 520.

When the valve 550 is opened, the cooling liquid CL may flow out from the third pipe 530. At this time, the state of the extracted cooling liquid CL may be checked. For example, the pH of the cooling liquid CL may be measured for use in maintaining or repairing the cooling system.

Due to the extracted cooling liquid CL, the amount of cooling liquid CL circulating in the cooling system may decrease. Since the extraction of the cooling liquid CL may cause a shortage of the flow rate in the circulation system and degradation of cooling efficiency, it may be advantageous to adjust the amount of extracted cooling liquid CL for optimization of the cooling cycle. The third pipe 530 may extract the cooling liquid CL having the decreased flow velocity while passing through the expansion section 400, thereby reducing the amount of extracted cooling liquid CL. As a result, the decrease in pressure of the cooling liquid CL may be minimized.

The third pipe 530 may communicate with a portion of the expansion section 400 between the first part 410 and the second part 420. As a result, the third pipe 530 may extract the cooling liquid CL having the decreased flow velocity, thereby reducing the amount of extracted cooling liquid CL.

The third pipe 530 may communicate with the portion of the expansion section 400 that has the largest cross-sectional area in the direction perpendicular to the Y axis. As a result, the third pipe 530 may extract the cooling liquid CL having the decreased flow velocity, thereby reducing the amount of extracted cooling liquid CL.

Further, by extracting the cooling liquid CL having the decreased flow velocity, the operation state of the cooling system may be maintained. The cooling system does not need to be stopped for the extraction of the cooling liquid CL.

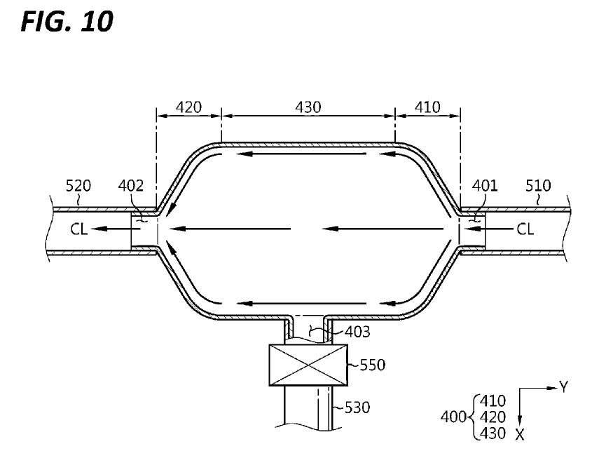

FIG. 10 is a view illustrating a modification of FIG. 8.

Referring to FIG. 10, the expansion section 400 may further include a third part 430. The third part 430 may be formed between the first part 410 and the second part 420. The third part 430 may extend from the first part 410. The second part 420 may extend from the third part 430. The third part 430 may connect the first part 410 and the third part 430 to each other. The third part 430 may have the cross-sectional area that is constant along the Y-axis direction. The cooling liquid CL passing through the third part 430 may maintain the constant flow velocity. The flow velocity of the cooling liquid CL flowing through the third part 430 may be lower than the flow velocity of the cooling liquid CL flowing through the first part 410. The flow velocity of the cooling liquid CL flowing through the third part 430 may be lower than the flow velocity of the cooling liquid CL flowing through the second pipe 420.

The outlet 403 may be formed in the third part 430. The third pipe 530 may communicate with the third part 430. Since the third pipe 530 communicates with the third part 430, the cooling liquid CL may be stably extracted.

An energy storage system (ESS) according to the present disclosure may include the plurality of battery containers 1000 according to the present disclosure. The energy storage system may form a link group by combining a certain number of battery containers 1000 and a control container.

Meanwhile, in the descriptions herein, expressions indicating directions such as "up," "down," "left," "right," "front," and "rear" are used. It is obvious to those skilled in the art that the expressions are used only to facilitate the description, and may vary, for example, depending on the location of a target object or an observer.

While the present disclosure has been described using limited embodiments and drawings, the present disclosure is not limited thereto, and it may be appreciated that various modifications and changes may be made by those having ordinary skill in the art of the present disclosure within the technical idea of the present disclosure and the equitable scope of the claims set forth below.

What is claimed is:

1. A battery container comprising:
a battery pack;
a chiller configured to supply a cooling liquid to the battery pack;
a first pipe communicating with the battery pack;
a second pipe communicating with the chiller; and
an expansion section providing communication between the first pipe and the second pipe, wherein a cross-sectional area of the expansion section is larger than each of cross-sectional areas of the first pipe and the second pipe.

2. The battery container according to claim 1, further comprising:
a third pipe communicating with the expansion section.

3. The battery container according to claim 2, further comprising:
a valve configured to open and close the third pipe.

4. The battery container according to claim 2, wherein the third pipe communicates with a portion of the expansion section, and a cross-sectional area of the portion is larger than the each of cross-sectional areas of the first pipe and the second pipe.

5. The battery container according to claim 2, wherein the expansion section includes a first part having a cross-sectional area that increases along a direction from the first pipe toward the second pipe.

6. The battery container according to claim 5, wherein the expansion section includes a second part having a cross-sectional area that decreases along the direction from the first pipe toward the second pipe.

7. The battery container according to claim 6, wherein the third pipe communicates with a portion of the expansion section between the first part and the second part.

8. The battery container according to claim 2, wherein the third pipe communicates with a portion of the expansion section having a largest cross-sectional area.

9. The battery container according to claim 2, wherein one end of the third pipe is opened.

10. An energy storage system comprising:
the battery container of claim 1.

11. The battery container according to claim 1, further comprising:
a fourth pipe configured to allow the cooling liquid flowing out from the battery pack to flow therethrough, and causing the battery pack and the chiller to communicate with each other.

12. The battery container according to claim 11, wherein the first pipe supplies the cooling liquid to a plurality of battery packs through a plurality of first branch pipes, and
the fourth pipe collects the cooling liquid from the plurality of battery packs through a plurality of second branch pipes.

13. The battery container according to claim 2, wherein the expansion section has a spherical or ellipsoidal shape, which is symmetrical relative to a central axis at which the third pipe communicates with the expansion section.

14. The battery container according to claim 3, wherein the valve is any one of a roller clamp, a flow regulator, or an infusion pump.

15. The battery container according to claim 6, wherein the expansion section further includes a third part formed between the first part and the second part, extending from the first part, and having a cross-sectional area that is constant along a flow direction of the cooling liquid, and
the third pipe communicates with the third part.
